(19) United States
(12) Patent Application Publication
(10) Pub. No.: US 2024/0318441 A1
(43) Pub. Date: Sep. 26, 2024

(54) Backpack device

(71) Applicant: Hilti Aktiengesellschaft, Schaan (LI)

(72) Inventors: Andreas Janecke, Landsberg am Lech (DE); Johannes Hammer, Vaduz (LI)

(21) Appl. No.: 18/578,178

(22) PCT Filed: Jul. 18, 2022
(86) PCT No.: PCT/EP2022/070017

§ 371 Date: Jan. 10, 2024

(30) Foreign Application Priority Data
Jul. 20, 2021 (EP) 21186547.2

(51) Int. Cl. E04G 21/06; A45F 3/00; A45F 3/10; B25F 5/02

(52) U.S. Cl. CPC E04G 21/063; A45F 3/10; A45F 2003/003; B25F 5/02

(57) ABSTRACT

A backpack device having a harness unit and a battery pack receptacle for receiving a battery pack for supplying a hand-held concrete vibrator with energy, wherein the concrete vibrator has an elastically deformable protective hose, and wherein the backpack device has a hose guide via which the protective hose can be guided with a load-transferring effect over a shoulder of a user of the backpack device.

The present invention relates to a backpack device having a harness unit and a battery pack receptacle for receiving a battery pack which is intended to supply a hand-held concrete vibrator with energy. The concrete vibrator has preferably an elastically deformable protective hose.

### BACKGROUND

EP 3 605 784 A1 discloses a carrying device having a carrying frame and an energy store carried by the carrying frame.

DE 10 2004 001 550 A1 discloses an electric hand-held power tool having at least one battery-powered electric motor which is able to be placed on a user's back by means of a carrying unit and by means of which an output tool is able to be driven via a flexible shaft, wherein the carrying unit has guide means that act on the flexible shaft such that, starting from the user's back, the flexible shaft is secured in the shoulder region so as to be unable to slip.

### SUMMARY OF THE INVENTION

It is an object of the present invention is to specify a backpack device which promotes increased user safety and increased user comfort.

The present application provides that the backpack device has a hose guide by means of which the protective hose can be guided with a load-transferring effect over a shoulder of a user of the backpack device.

The invention incorporates the finding that a hand-held concrete vibrator is typically very heavy and it is accordingly difficult for a user to use. This can have negative effects on the user's health in the long term. It has also been found that the surface of already compacted concrete can be damaged by contact with the protective hose, resulting in rectification work being required.

Since the protective hose can be guided with a load-transferring effect over a shoulder of a user of the backpack device, avoidance of these drawbacks is promoted. A part of the vertical load of the concrete vibrator can be introduced into the backpack device via the protective hose that is now guided in the hose guide. This protects the user's back. In addition, the hose guide can promote ideally vertical introduction of a vibrating cylinder of the concrete vibrator into the concrete to be compacted.

In a particularly preferred configuration, the hose guide is designed to allow the protective hose to still be movable along its longitudinal direction. It has been found to be advantageous when the hose guide is designed to allow the protective hose to still be movable in a horizontal direction, in particular a contact point or in a contact zone between the protective hose and hose guide.

It has also been found to be advantageous when the backpack device has a housing separate from the harness unit and/or arranged on the harness unit. In a particularly preferred configuration, the hose guide is arranged on the housing. The housing can be in the form of a hood. It has been found to be advantageous when the housing is aligned with the battery pack receptacle.

In a particularly preferred configuration, the harness unit has two shoulder straps and/or a base plate. In a further particularly preferred configuration, the base plate is fastened to the harness unit, in particular releasably fastened thereto. It has been found to be advantageous when the base plate is arranged centrally on the harness unit with respect to a horizontal direction when the harness unit is used as intended. It has also been found to be advantageous when the hose guide is at a distance from the shoulder straps, in particular in a vertical direction. In a further particularly preferred configuration, load transfer from the protective hose and/or the hose guide to a user takes place via the base plate.

In a particularly preferred configuration, the hose guide is integrated in the housing. It has been found to be advantageous when the hose guide is formed in one piece with the housing. In a particularly preferred configuration, the housing and/or the hose guide consists of plastic or exhibits plastic. It has been found to be advantageous when the plastic is a thermoplastic, which has preferably been processed by means of an injection-molding process to form the housing and/or the hose guide.

In a further particularly preferred configuration, the hose guide has at least one sliding surface. It has been found to be advantageous when the sliding surface has a coefficient of sliding friction of rubber (protective hose) on plastic (hose guide) in a dry state of between 0.2 and 0.4 according to DIN EN ISO 8295. The hose guide may be provided with a sliding surface comprising a plastic from the group: polyamide, polyacetal copolymer, polyethylene terephthalate, polytetrafluoroethylene.

In a particularly preferred embodiment, the hose guide has a convex surface. The hose guide may have an at least partially curved surface. It has been found to be advantageous when the surface extends across most of the width of the housing. The surface may be delimited on both sides, in a horizontal direction, by respective raised collars. As a result, lateral slipping of the protective hose from the hose guide can be avoided.

In a further particularly preferred configuration, the hose guide has an extension rail for partially receiving the protective hose. Load transfer from the protective hose takes place preferably via this extension rail. In a particularly preferred configuration, the extension rail has a U-shaped profile. It has been found to be advantageous when the extension rail is arranged on the housing so as to be pivotable and/or movable in translation relative to the housing. The extension rail may be pivotable in one or more degrees of freedom with respect to the housing. It has been found to be advantageous when the extension rail is configured to be lockable. In particular, provision may be made for it to be possible for one or more degrees of freedom of the extension rail to be blocked by a user if necessary. In a particularly preferred configuration, the housing has a plurality of defined receiving zones for the extension rail. It has been found to be advantageous when the receiving zone has a cutout in which the corresponding peg of the extension rail can engage. Preferably, engagement takes place without noticeable play or with scarcely noticeable play. The cutout may have an orientation groove formed on the cutout, said orientation groove preferably meaning that the cutout has a non-rotationally symmetric configuration. In this way, a particular pivot angle position for the extension rail can be set. Different cutouts may have orientation grooves oriented at different angles.

In a further particularly preferred configuration, the extension rail has at least one transport roller. It has been found to be advantageous when the transport roller is arranged within a volume defined by the extension rail. The extension rail may have a length of at least 30 cm.

In a further particularly preferred configuration, the battery pack receptacle is arranged beneath the hose guide. It has been found to be advantageous when the hose guide projects at least partially, in a vertical direction, beyond the highest point of the harness unit.

The present invention also provides a concrete vibrator system having an above-described backpack device and having a hand-held concrete vibrator, which is connected or able to be connected to the backpack device via an elastically deformable protective hose, wherein the concrete vibrator is assigned an electric motor. The concrete vibrator system may be developed by features described in relation to the backpack device.

In a particularly preferred configuration, the electric motor is arranged in the backpack device. In a further particularly preferred configuration, the protective hose has a mechanical driveshaft driven by the electric motor. As an alternative to the electric motor being arranged in the backpack device, the electric motor can be arranged in a vibrating cylinder of the concrete vibrator. It has been found to be advantageous when the protective hose comprises or is an electrical cable. In a particularly preferred configuration, the electric motor is connected to the battery pack via the electrical cable.

In a further particularly preferred configuration, the concrete vibrator system has a battery pack received or able to be received in the battery pack receptacle, by means of which the electric motor of the concrete vibrator can be supplied with electricity.

Further advantages will become apparent from the following description of the figures. Particularly preferred exemplary embodiments of the present invention are illustrated in the figures. The figures, the description and the claims contain numerous features in combination. A person skilled in the art will expediently also consider the features individually and combine them to form useful further combinations.

### BRIEF DESCRIPTION OF THE DRAWINGS

Identical and similar components are denoted by the same reference signs in the figures, in which:

FIG. 1 shows a first preferred exemplary embodiment of a backpack device,

FIG. 2 shows the exemplary embodiment in FIG. 1 from a different viewing angle,

FIG. 3 shows a second preferred exemplary embodiment of a backpack device, and

FIG. 4 shows the exemplary embodiment in FIG. 3 from a different viewing angle.

### DETAILED DESCRIPTION

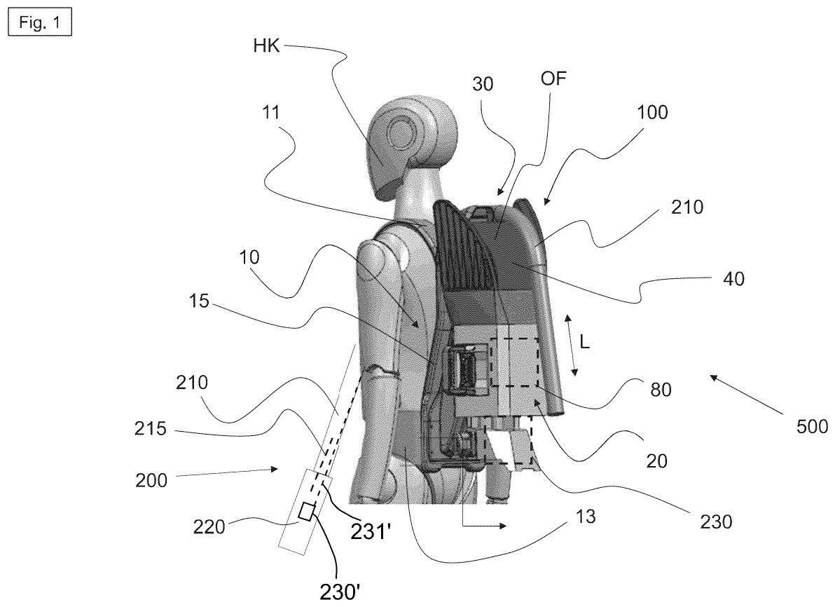

A first preferred exemplary embodiment of a backpack device 100 according to the invention is illustrated in FIG. 1.

The backpack device 100 is equipped with a harness unit 10 and a battery pack receptacle 20 for receiving a battery pack 80 (illustrated by dashed lines since it is arranged within the battery pack receptacle 20). The battery pack 80, that is received in the battery pack receptacle 20, serves to supply a hand-held concrete vibrator 200 with energy, wherein the concrete vibrator 200 has an elastically deformable protective hose 210.

The harness unit 10 for its part has two shoulder straps 11 and a base plate 15 connected to the shoulder straps. The battery pack receptacle 20 is connected to the base plate 15 such that the load of the battery pack 80 can be transferred evenly to a user HK of the backpack device 100 via the base plate 15 and the two shoulder straps 11. The harness unit 10 is equipped for example with a waist strap 13 in order to realize even better load distribution.

The backpack device 100, the hand-held concrete vibrator 200 and the battery pack 80 are part of a concrete vibrator system 500. In the exemplary embodiment illustrated here, the concrete vibrator 200 is assigned an electric motor 230, which is arranged in the backpack device 100 (in this case for example beneath the battery pack receptacle 20). The electric motor 230 is supplied with electricity by the battery pack 80. The elastically deformable protective hose 210 contains a flexible mechanical driveshaft 215, via which a rotary movement of the electric motor 230 is transmitted to an unbalance mass of a vibrating cylinder 220 of the concrete vibrator 200.

In an alternative exemplary embodiment illustrated solely schematically and alternatively, the electric motor 230′ can be arranged in the vibrating cylinder of the concrete vibrator. In this case, the protective hose comprises an electrical cable 231′ via which the electric motor is connected to the battery pack.

As can be gathered from FIG. 1, the backpack device 100 has a hose guide 30 by means of which the protective hose 210 is guided with a load-transferring effect over a shoulder of the user HK of the backpack device 100. In this case, the hose guide 30 is designed to allow the protective hose 210 to still be movable along its longitudinal direction L.

The backpack device 100 has a housing 40 separate from the harness unit 10 and arranged on the harness unit 10, wherein the hose guide 30 is arranged on the housing 40. In the first preferred exemplary embodiment illustrated here, the hose guide 30 is formed in one piece with the housing 40. For example, the housing 40 consists of an ABS plastic, which has been fashioned into the housing 40 by means of injection molding. The housing 40 is in the form of a hood, wherein the hose guide 30 formed in one piece with the housing 40 has a convex surface OF. The convex surface OF follows a curvature of the shoulder straps 11, which conform to the shape of the shoulders of the user HK when the backpack device 100 is being used as intended. In other words, it may be advantageous when the convex surface OF, with respect to the position and/or form of its curvature, is modeled on the shoulders and/or the back of the user HK.

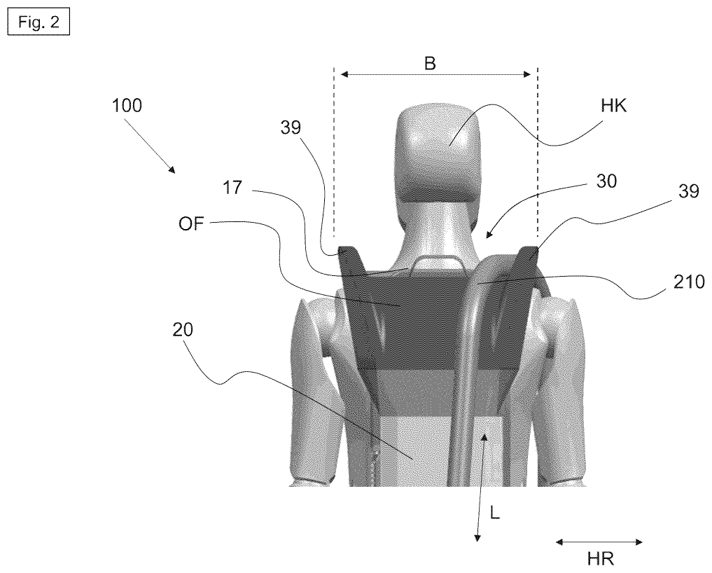

As can be gathered from FIG. 2, the convex surface OF extends across a major part of the width B of the housing 40. In this case, the convex surface OF is delimited on both sides, in a horizontal direction HR, by respective raised collars 39. As a result, lateral slipping of the protective hose 210 from the hose guide 30 is prevented. The surface OF configured in this way makes it possible for the protective hose 210 to still be movable along its longitudinal direction L; in other words, as a result of gravity, the protective hose rests on the surface OF of the hose guide 30 and can slide along the latter. In particular, the protective hose 210 is not fixed to the hose guide 30 in a contact zone between the protective hose 210 and hose guide 30. Thus, introduction of vibrations from the protective hose 210 into the backpack device 100 is avoided at least to a certain extent.

Since the convex surface OF extends across a major part of the width B of the housing 40, the protective hose 210 also has a degree of freedom in a horizontal direction HR. The user can thus also shift the protective hose 210 slightly, for example while transferring the protective hose 210 to the left shoulder.

The backpack device 100 has a handle 17 which is fastened to the base plate 15 and by means of which the backpack device 100 can be lifted comfortably, for example onto the loading bed of a vehicle.

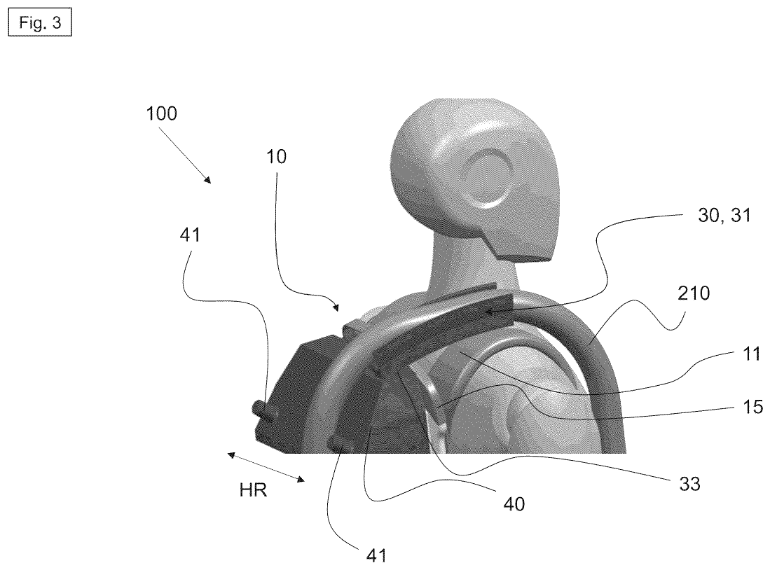

A second preferred exemplary embodiment of a backpack device 100 according to the invention is illustrated in FIG. 3. The backpack device 100 has a housing 40 separate from the harness unit 10 and fastened to the base plate 15 of the harness unit 10, wherein the hose guide 30 is arranged on the housing 40. For the purpose of guiding the protective hose 210 with a load-transferring effect, the hose guide 30 has an extension rail 31.

The extension rail 31 is releasably fastened to the housing 40. In order to prevent the protective hose 210 from slipping laterally (in a horizontal direction HR) from the housing 40, the housing 40 has two limiting studs 41. Lateral slipping (in a horizontal direction HR) of the protective hose 210 from the extension rail 31 is avoided in that the extension rail 31 has a U-shaped profile in which the protective hose 210 is at least partially received.

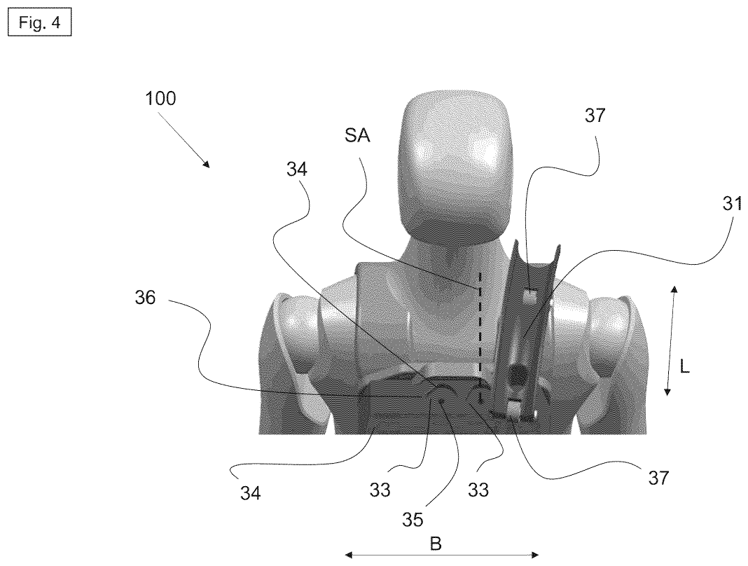

Preferably, the extension rail 31 is arranged on the housing 40 so as to be movable in translation relative to the housing 40. This is intended to be explained in more detail with reference to FIG. 4. The housing 40 has a plurality of defined receiving zones 33 for the extension rail 31. Each of the receiving zones 33 in turn has a cutout 34, into which a corresponding peg (not illustrated here) of the extension rail 31 can engage without noticeable play or with scarcely noticeable play. By means of a holding pin (not illustrated here) on the underside of the extension rail 31, the extension rail 31 can be secured against slipping out, for example by the holding pin (not illustrated here) latching in a centrally arranged pin receptacle 35 of the receiving zone 33. Each of the receiving zones 33 defines an anchoring position of the extension rail 31 along a width B of the housing 40. Thus, the extension rail 31 is arranged on the housing 40 so as to be movable in translation relative to the housing 40.

Putting the extension rail 31 into a defined pivoted position (in each case with respect to a pivot axis SA extending coaxially with the pin receptacle) can be realized for example by a circular cutout 34 in the receiving zone 33. In this case, the extension rail 31 remains in one and the same cutout 34 and is variably pivotable in the manner of a slewing crane about the pivot axis SA of the adopted cutout 34. On the other hand, a particular pivot angle position for the extension rail 31 can be set by an orientation groove 36 formed on the cutout 34, said orientation groove 36 meaning that the cutout 34 has a non-rotationally symmetric configuration. The cutouts 34 may have orientation grooves oriented at different angles.

As can likewise be gathered from FIG. 4, the extension rail 31 has a U-shaped profile, in which the protective hose 210 (cf. FIG. 3) is at least partially received. The extension rail 31 has two transport rollers 37, which promote the guidance of the protective hose 210 in the longitudinal direction L.

What is claimed is:

1-14. (canceled)

15: A backpack device comprising:
a harness unit;
a battery pack receptacle for receiving a battery pack for supplying a hand-held concrete vibrator with energy, wherein the concrete vibrator has an elastically deformable protective hose; and
a hose guide, the protective hose guidable via the hose guide with a load-transferring effect over a shoulder of a user of the backpack device.

16: The backpack device as recited in claim 15 wherein the hose guide is designed to allow the protective hose to still be movable along a longitudinal direction.

17: The backpack device as recited in claim 15 further comprising a housing separate from the harness unit, the hose guide being arranged on the housing.

18: The backpack device as recited in claim 15 further comprising a housing arranged on the harness unit, the hose guide being arranged on the housing.

19: The backpack device as recited in claim 15 further comprising a housing, the hose guide being integrated in the housing.

20: The backpack device as recited in claim 20 wherein the hose guide is formed in one piece with the housing.

21: The backpack device as recited in claim 19 wherein the hose guide has a convex surface.

22: The backpack device as recited in claim 21 wherein the convex surface extends across a major part of a width of the housing.

23: The backpack device as recited in claim 21 wherein the convex surface is delimited on both sides, in a horizontal direction, by respective raised collars.

24: The backpack device as recited in claim 15 further comprising a housing, the hose guide having an extension rail arranged on the housing.

25: The backpack device as recited in claim 24 wherein the extension rail is arranged on the housing so as to be pivotable or movable in translation relative to the housing.

26: The backpack device as recited in claim 24 wherein the housing has a plurality of defined receiving zones for the extension rail.

27: The backpack device as recited in claim 24 wherein the extension rail has at least one transport roller.

28: The backpack device as recited in claim 15 wherein the battery pack receptacle is arranged beneath the hose guide.

29: A concrete vibrator system comprising:
the backpack device as recited in claim 15; and
the hand-held concrete vibrator, the concrete vibrator connected or connectable to the backpack device via an elastically deformable protective hose, the concrete vibrator being assigned an electric motor.

30: The concrete vibrator system as recited in claim 29 wherein the electric motor is arranged in the backpack device or the protective hose has a mechanical driveshaft driven by the electric motor.

31: The concrete vibrator system as recited in claim 29 wherein the electric motor is arranged in a vibrating cylinder of the concrete vibrator, and the protective hose includes an electric cable via which the electric motor is connected to the battery pack.

32: The concrete vibrator system as recited in claim 29 wherein the concrete vibrator system has a battery pack received or receivable in the battery pack receptacle, the electric motor assigned to the concrete vibrator suppliable with electricity via the battery pack.
